(19) United States
(12) Patent Application Publication
(10) Pub. No.: US 2008/0253043 A1
(43) Pub. Date: Oct. 16, 2008

(54) Active matrix device and a flat panel display with electrostatic protection

(75) Inventors: Chi-Ming Wu, Hsinchu (TW); Chuan-Feng Liu, Hsinchu (TW)

Correspondence Address: THE WEBB LAW FIRM, P.C., 700 KOPPERS BUILDING, 436 SEVENTH AVENUE, PITTSBURGH, PA, 15219, US

(73) Assignee: PRIME VIEW INTERNATIONAL CO., LTD., Hsinchu (TW)

(21) Appl. No.: 11/821,633

(22) Filed: Jun. 25, 2007

(30) Foreign Application Priority Data
Apr. 14, 2007 (TW) 96108831

(51) Int. Cl. H02H 9/00

(52) U.S. Cl. 361/56

(57) ABSTRACT

An active matrix device or a flat panel display, includes a substrate, a plurality of scan lines and data lines, a plurality of pixels, an electrostatic discharge circuit, and a first electrostatic protection circuit, in which the scan lines, the data lines and the electrostatic discharge circuit are disposed on the substrate. The data lines are across the scan lines. The electrostatic discharge circuit is also across the scan lines and the data lines. The first electrostatic protection circuit is coupled to the electrostatic discharge circuit, but is neither coupled to the scan lines nor coupled to the data lines.

### RELATED APPLICATIONS

This application claims priority to Taiwan Application Serial Number 96108831, filed Mar. 14, 2007, which is herein incorporated by reference.

### BACKGROUND

1. Field of Invention

The present invention relates to an active matrix device. More particularly, the present invention relates to an active matrix device with electrostatic protection.

2. Description of Related Art

Generally speaking, the electrostatic voltage existing in the environment or in human beings may be as high as several thousand volts. In the manufacturing process of an active matrix device (such as Liquid Crystal Display, OLED display, and ElectroPhoretic Display), if the electrostatic current with such high voltage in an operator enters the active matrix device, the electronic devices of the active matrix device, such as Thin Field Transistor, might be destroyed.

To prevent the electronic devices from being damaged by the electrostatic current, an Electrostatic Discharge Ring (ESD Ring) is disposed on the substrate of the active matrix device. If there is electrostatic current on the scan lines, the data lines or the substrate, the electrostatic current is discharged to the ESD Ring and consumed by the ESD Ring, which prevents the electronic devices of the active matrix device from being damaged.

However, in such active matrix device, the single ESD Ring is not able to consume enough electrostatic energy, so that the electronic devices on the substrate may still be damaged by the remaining electrostatic energy.

For the forgoing reasons, there is a need for a new active matrix device which reduces the electrostatic energy more effectively to prevent the electronic devices on the substrate from being damaged.

### SUMMARY

According to one embodiment of the present invention, an active matrix device includes a substrate, a plurality of scan lines, data lines and pixels, at least one electrostatic discharge circuit and at least one first electrostatic protection circuit. The scan lines and the data lines are disposed on the substrate. The data lines are across the scan lines. The electrostatic discharge circuit, having at least one energy consumption area without data lines or scan lines disposed on, is also disposed on the substrate and interlaced the scan lines and the data lines. The first electrostatic protection circuit, disposed on the energy consumption area, is coupled to the electrostatic discharge circuit.

According to another embodiment of the present invention, a flat panel display includes a substrate, a plurality of scan lines and data lines, a plurality of Thin Field Transistors, at least one electrostatic discharge circuit, at least one first electrostatic protection circuit, and a plurality of second electrostatic protection circuits. The scan lines and the data lines are disposed on the substrate. The data lines are across the scan lines. The Thin Field Transistor has a gate coupled to the scan line and a first source/drain coupled to the data line.

The electrostatic discharge circuit, having at least one energy consumption area without data lines or scan lines disposed on, is disposed on the substrate and interlaced with the scan lines and the data lines. The first electrostatic protection circuit is disposed on the energy consumption area and coupled to the electrostatic discharge circuit. The second electrostatic protection circuits are coupled to the electrostatic discharge circuit and the data lines or the scan lines.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with the following description, appended claims, and accompanying drawings where:

FIG. 1 is an active matrix device according to one embodiment of the present invention;

FIG. 2A is a third electrostatic protection circuit according to one embodiment of the present invention;

FIG. 2B is the third electrostatic protection circuit according to another embodiment of the present invention;

FIG. 2C is the third electrostatic protection circuit according to the other embodiment of the present invention; and

FIG. 3 is the first electrostatic protection circuit.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

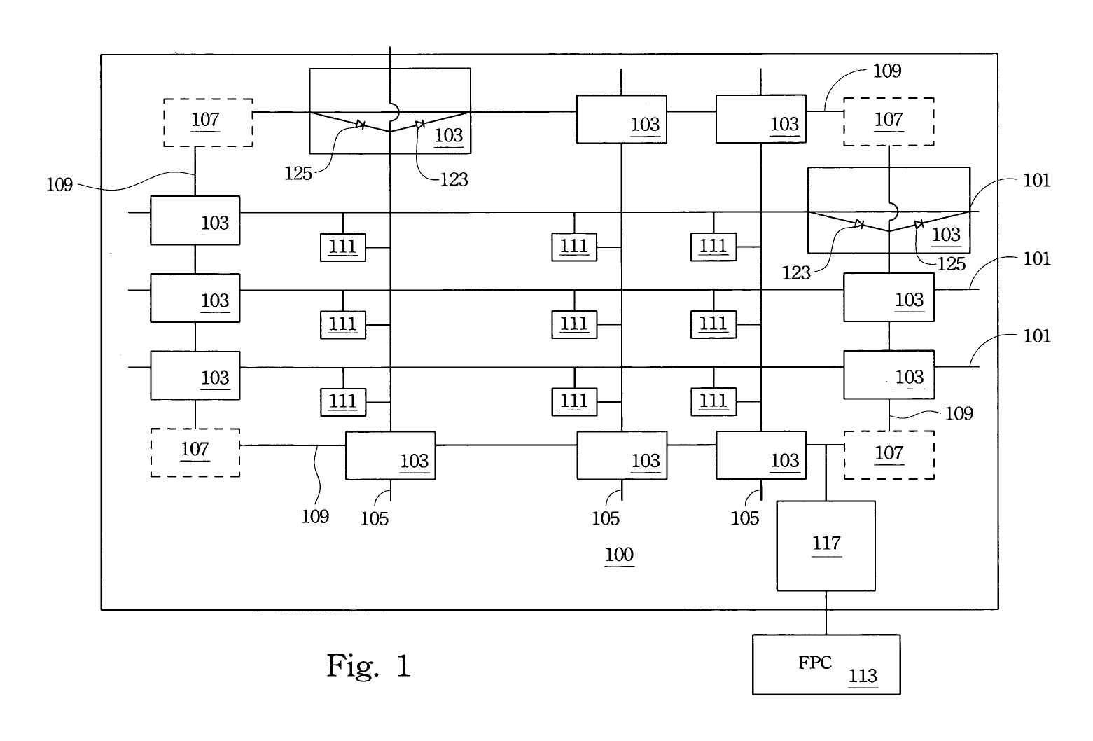

FIG. 1 is an active matrix device according to one embodiment of the present invention. The active matrix device includes a substrate 100, scan lines 101, data lines 105, pixels 111, a first electrostatic protection circuit 107, a second electrostatic protection circuit 103, and an electrostatic discharge circuit 109.

The Scan lines 101, the data lines 105, the pixels 111, the first electrostatic protection circuit 107, the second electrostatic protection circuit 103 and the electrostatic discharge circuit 109 are disposed on the substrate 100. The pixels 111 are coupled to the scan lines 101 and the data lines 105. The scan lines 101 and the data lines 105 are coupled to the electrostatic discharge circuit 109 through the second electrostatic protection circuit 103.

If the active matrix device is a thin film transistor liquid crystal display, the pixels 111 include at least one thin film transistor (not shown) which has a gate coupled to the scan line, and a first source/drain coupled to the data line. The thin film transistor delivers the voltage on the data line to the pixel 111 in the scanning period.

The second electrostatic protection circuit 103 includes a third diode 125 and a fourth diode 123, in which the anode and the cathode of the fourth diode 123 are coupled to the scan lines 101 (or the data line 105) and the electrostatic discharge circuit 109 respectively. The anode and the cathode of the third diodes 125 are coupled to the electrostatic discharge circuit 109 and scan line 101 (or the data line 105) respectively.

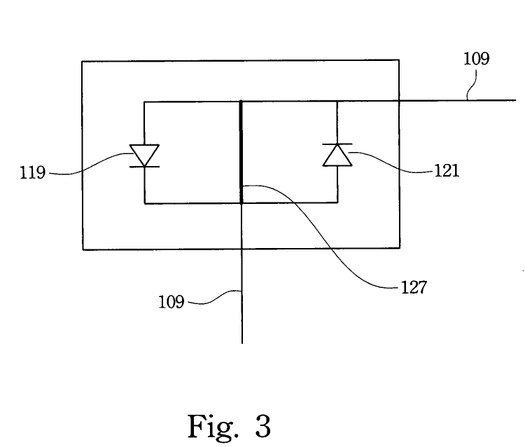

The positive or negative electrostatic current appearing on the data lines or the scan lines is delivered to the electrostatic discharge circuit 109 through the fourth diode 123 and the third diode 125. The electrostatic discharge circuit 109 along with the first diodes 119 and the second diodes 121 (shown in FIG. 3) of the first electrostatic protection circuits 107 consume the electrostatic energy more effectively than the single electrostatic discharge ring.

In addition, a third electrostatic protection circuit 117 can be added between the electrostatic discharge circuit 109 and a printed circuit board, such as a flexible printed circuit board 113 (FPC). The third electrostatic protection circuit 117 is able to consume or block the electrostatic current while the electrostatic current tries to enter the substrate 100 from the flexible printed circuit board 113. Therefore, the electronic components on the substrate 100 can be saved from being damaged by the electrostatic energy.

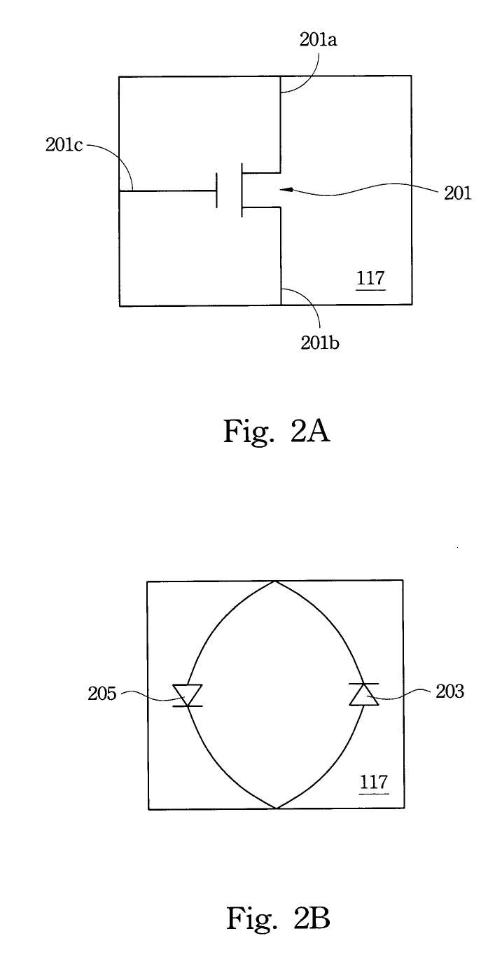

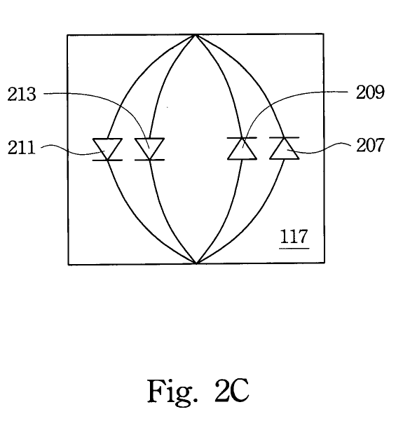

FIG. 2A shows one kind of the third electrostatic protection circuit according to one embodiment of the present invention. The third electrostatic protection circuit 117 can be a transistor 201. The first source/drain 201a and the second source/drain 201b of the transistor 201 are coupled to the electrostatic discharge circuit 109 and FPC 113, respectively. The gate 201c of the transistor 201 is floating.

Because the gate 201c of the transistor 201 is floating, the transistor 201 is off, which blocks the electrostatic current on the FPC 113 from entering the electrostatic discharge circuit 109 on the substrate 100. So the electronic components on the substrate 100 can be saved from being damaged by the electrostatic current from the FPC 113.

FIG. 2B shows another kind of the third electrostatic protection circuit according to one embodiment of the present invention. The third electrostatic protection circuit 117 includes a fifth diode 205 and a sixth diode 203. The anode and cathode of the sixth diode 203 are coupled to the FPC 113 and electrostatic discharge circuit 109 respectively. The anode and cathode of the fifth diode 205 are coupled to electrostatic discharge circuit 109 and the FPC 113, respectively.

The positive and negative electrostatic current are consumed by the sixth diode 203 and the fifth diode 205 while they are going from the FPC 113 to the electrostatic discharge circuit 109. So the electronic components on the substrate 100 can be saved from being damaged by the electrostatic current from FPC 113.

FIG. 2C shows the other kind of the third electrostatic protection circuit according to one embodiment of the present invention. The third electrostatic protection circuit 117 includes the diode 207, the diode 209, the diode 211 and diode 213. The configurations of diode 207, the diode 209, the diode 211 and the diode 213 are the same as the sixth diode 203 and the fifth diode 205 shown in FIG. 2B. With two more diodes added, the third electrostatic protection circuit 117 can consume the electrostatic energy more effectively.

FIG. 3 is the first electrostatic protection circuit according to one embodiment of the present invention. The first electrostatic protection circuit 107 includes the first diode 119 and the second diode 121. The first diode 119 and the second diode 121 are electrically connected to the electrostatic discharge circuit 109. The anode and cathode of the first diode 119 are coupled to the cathode and the anode of the second diode 121 respectively. The number of the first diode 119 and the second diode 121 can be increased as required.

In addition to the first diode 119 and the second diode 121, a conducting wire 127 can also be added in the first electrostatic protection circuit 107. One end of the conducting wire 127 is electrically connected to the electrostatic discharge circuit 109, the anode of the first diode 119, and the cathode of second diode 121. The other end of the conducting wire 127 is electrically connected to the electrostatic discharge circuit 109, the cathode of the first diode 119, and the anode of the second diode 121.

If the first diode 119 and the second diode 121 are destroyed, the electrostatic energy can still be consumed by the electrostatic discharge circuit 109 with the conducting wire 127 added.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An active matrix device, comprising:
a substrate;
a plurality of scan lines disposed on the substrate;
a plurality of data lines, disposed on the substrate and across the scan lines;
a plurality of pixels, coupled to the data lines and the scan lines;
at least one electrostatic discharge circuit, disposed on the substrate and interlaced the scan lines and the data lines, wherein the electrostatic discharge circuit has at least one energy consumption area in the absence of the data lines and the scan lines; and
at least one first electrostatic protection circuit, disposed on the energy consumption area, coupled to the electrostatic discharge circuit.

2. The active matrix device of claim 1, wherein the first electrostatic protection circuit comprises:
at least one first diode; and
at least one second diode, having an anode coupled to a cathode of the first diode, and a cathode coupled to an anode of the first diode.

3. The active matrix device of claim 1, further comprising a plurality of second electrostatic protection circuits coupled to the electrostatic discharge circuit and the data lines or the scan lines.

4. The active matrix device of claim 3, wherein each second electrostatic protection circuits comprises:
at least one third diode, having an anode coupled to the electrostatic discharge circuit and a cathode coupled to the data line or the scan line; and
at least one fourth diode, having an anode coupled to the data line or the scan line and a cathode coupled to the electrostatic discharge circuit.

5. The active matrix device of claim 1, further comprising:
a printed circuit board; and
a third electrostatic protection circuit, coupled to the printed circuit board and the electrostatic discharge circuit.

6. The active matrix device of claim 5, wherein the printed circuit board is a flexible printed circuit board.

7. The active matrix device of claim 5, wherein the third electrostatic protection circuit comprises a transistor having a first source/drain coupled to the electrostatic discharge circuit, a second source/drain coupled to the printed circuit board, and a floating gate.

8. The active matrix device of claim 5, wherein the third electrostatic protection circuit comprise:
at least one fifth diode, having an anode coupled to the electrostatic discharge circuit, and a cathode coupled to the printed circuit board; and
at least one sixth diode, having an anode coupled to the printed circuit board, and a cathode coupled to the electrostatic discharge circuit.

9. The active matrix device of claim 1, wherein the substrate is made of glass.

10. The active matrix device of claim 1, wherein the substrate is made of plastic.

11. A flat panel display, comprising:
a substrate;
a plurality of scan lines disposed on the substrate;
a plurality of data lines, across the scan lines, disposed on the substrate;
a plurality of Thin Field Transistors, each having a gate coupled to the scan line, and a first source/drain coupled to the data line;
at least one electrostatic discharge circuit, disposed on the substrate and interlaced the scan lines and the data lines, having at least one energy consumption area without data lines or scan lines disposed on;
at least one first electrostatic protection circuit, disposed on the energy consumption area, coupled to the electrostatic discharge circuit; and
a plurality of second electrostatic protection circuits, coupled to the electrostatic discharge circuit and the data lines or the scan lines.

12. The flat panel display of claim 11, wherein the first electrostatic protection circuit comprises:
at least one first diode; and
at least one second diode, having an anode coupled to a cathode of the first diode and a cathode coupled to an anode of the first diode.

13. The flat panel display of claim 11, wherein each second electrostatic protection circuits comprises:
at least one third diode having an anode coupled to the electrostatic discharge circuit and a cathode coupled to the data line or the scan line; and
at least one fourth diode having an anode coupled to the data line or the scan line and a cathode coupled to the electrostatic discharge circuit.

14. The flat panel display of claim 11, further comprising:
a printed circuit board; and
a third electrostatic protection circuit, coupled to the printed circuit board and the electrostatic discharge circuit.

15. The flat panel display of claim 14, wherein the printed circuit board is a flexible printed circuit board.

16. The flat panel display of claim 14, wherein the third electrostatic protection circuit comprises a transistor having a first source/drain coupled to the electrostatic discharge circuit, a second source/drain coupled to the printed circuit board, and a floating gate.

17. The flat panel display of claim 14, wherein the third electrostatic protection circuit comprise:
at least one fifth diode, having an anode coupled to the electrostatic discharge circuit, and a cathode coupled to the printed circuit board; and
at least one sixth diode, having an anode coupled to the printed circuit board, and a cathode coupled to the electrostatic discharge circuit.
